(19) United States
(12) Patent Application Publication
(10) Pub. No.: US 2009/0041016 A1
(43) Pub. Date: Feb. 12, 2009

(54) Method, system and device to track and record user call experience

(75) Inventor: Sanjay Bhal, Boyd, MD (US)

Correspondence Address: TEXAS INSTRUMENTS INCORPORATED, P O BOX 655474, M/S 3999, DALLAS, TX, 75265, US

(73) Assignee: Texax Instruments Incorporated, Dallas, TX (US)

(21) Appl. No.: 11/890,484

(22) Filed: Aug. 7, 2007

(51) Int. Cl. H04L 12/56

(52) U.S. Cl. 370/392

(57) ABSTRACT

A computer-implemented method, system, and device are described for managing user call experiences in a packet network. User devices are grouped into network clusters. A network infrastructure device receives objective quality information for calls on a packet network for each user device in a network cluster in the packet network. A portion of the user devices in the network cluster is selected, and subjective quality information representing a call experience rating is obtained from each selected user device. The network infrastructure device generates a signature for each user device in the network cluster using the objective and any subjective quality information. The signature represents a user experience during a call, indicates network elements specific to the call and a user device configuration during the call. The signatures of the portion are analyzed to determine a golden signature for the network cluster, the golden signature representing a preferred call experience.

### TECHNICAL FIELD

The technical field relates in general to communication networks, and more specifically to managing call quality over a communication network.

### BACKGROUND

Quality of user experience in connection with voice communications can be a subjective measure from the user's perspective of the overall value of the service provided. Nevertheless, apart from the user's call experience being user dependent, a user's call experience can be influenced by the user device and its configuration, as well as the environment in which the user device is used.

The quality of the user call experience also can be impacted by the flow of packets that carry the communications from sender to receiver. Voice over packet (VOP) data streams can be especially dramatically impacted by dropped packets, jitter, out-of-order delivery, and/or other errors and line quality.

Mathematical models are available to attempt to model the user's voice call experience. Nevertheless, the actual user experience is not reflected in such models.

### SUMMARY

Accordingly, one or more embodiments provide a system, computer-readable medium, and/or computer-implemented method for managing user call experiences in a packet network, wherein user devices are grouped into network clusters, wherein network elements in the packet network can be different for different calls for the same user device. A network infrastructure device receives, from network elements, objective quality information for calls on a packet network for each user device of plural user devices in a network cluster in the packet network. Also included is selecting a portion of the user devices in the network cluster, interacting with each user device of the portion to obtain subjective quality information for each user device of the portion, and receiving the subjective quality information, wherein the subjective quality information represents a call experience rating. The network infrastructure device generates a signature for each of the plural user devices in the network cluster using the objective quality information for the each user device in the network cluster and any subjective quality information for the each user device, wherein the signature represents a user experience during a call, indicates network elements specific to the call, and indicates a user device configuration during the call; and analyzes the signatures corresponding to the user devices of the portion to determine a golden signature for the network cluster, wherein the golden signature represents a preferred call experience.

One or more embodiments can provide a system for managing user call experiences in a packet network, wherein user devices are grouped into network clusters, wherein network elements in the packet network can be different for different calls for the same user device. A memory is configured to store signatures for plural users. A processor is configured to facilitate receiving, from network elements, objective quality information for calls on a packet network from each user device of plural user devices in a network cluster in the packet network, selecting a portion of the user devices within the network cluster, and gathering subjective quality information from each user device of the portion. The subjective quality information represents a call experience rating. The processor is configured for generating a signature for each of the plural user devices in the network cluster using the objective quality information for the each user device in the network cluster. The signature represents a user experience during a call, indicates network elements specific to the call, and indicates a user device configuration during the call. The processor is further capable of using the signatures stored in the memory for subsequent comparisons within the network cluster, for troubleshooting, and for cluster analysis.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a diagram illustrating a simplified and representative environment arranged for managing user call experiences on user devices in a packet network;

FIG. 2 is a block diagram illustrating portions of a system for managing user call experiences in a packet network;

FIG. 3 is a flow chart illustrating a procedure for managing user call experiences in a packet network;

FIG. 4 is a flow chart illustrating a procedure for collecting subjective quality information; and

FIG. 5 is a flow chart illustrating a procedure for adjusting user call experiences in a packet network.

### DETAILED DESCRIPTION

In overview, the present disclosure concerns communication networks, often referred to as packet networks, or more particularly voice over packet (VOP) networks, such as may be associated with networks supporting voice communication between wireless and/or wire line devices. Such communication networks may provide additional services such as data communications, signal, and/or video services. Such networks can include network infrastructure devices which transfer the communications between wireless and/or wire line devices, for example by forwarding the communications which may have been broken into communication packets. More particularly, various inventive concepts and principles are embodied in systems, devices, and methods therein for managing user call experiences in a packet network.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed to track and record the user's call experience.

Further in accordance with exemplary embodiments, users are selected (for example, randomly) to input call experience ratings, which can be transported, for example via SIP (session initial protocol) NOTIFY, and/or other packet communications with other RTCP XR (real time control protocol extended reports) extensions. Also, the configuration of the user's device, the topology of the network used by the user device, and voice service routes can be transported. Once the call experience ratings (reflecting the subjective user call experience) are collected, further statistical analysis and modeling can be carried out to determine one or more golden signatures for a network cluster, that is signatures associated with preferred user experiences.

Using the collected signatures about good or bad call experiences, data mining can be carried out to identify golden signatures and/or bad signatures which are associated with a network cluster. For example, the user's bad or good experience can be analyzed with regard to the signature; golden signatures and bad signatures can be clustered; and/or network conditions can be monitored to determine how the user experience is affected. Service providers and/or equipments vendors can identify a cause of the user experience and make corrections.

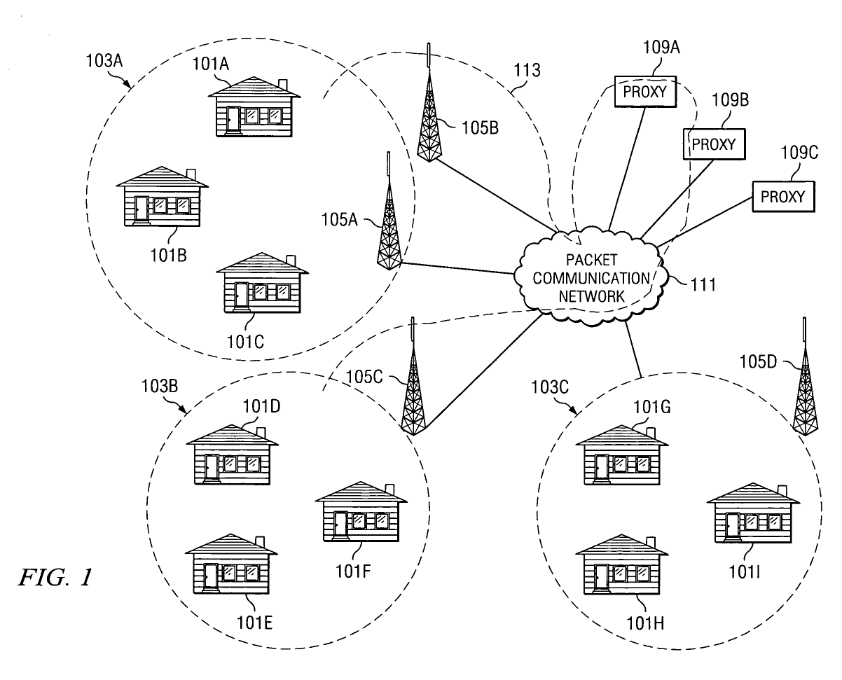

Referring now to FIG. 1, a diagram illustrating a simplified and representative environment arranged for managing user call experiences on user devices in a packet network will be discussed and described. In this illustration, user devices 101A, 101B, 101C are representative of user devices in a network cluster 103A. Also illustrated are additional network cluster 103B with user devices 101D, 101E, 101F, and further network cluster 103C with user devices 101G, 101H, 101I.

The illustration also includes network infrastructure devices 105A, 105B, 105C, 105D, proxies 109A, 109B, 109C, which are included in a packet communication network. Additional network infrastructure devices are generally represented in this illustration by the packet communication network 111. A routing path taken by a packet between user device 101A and user device 101D in different network clusters through the packet communication network 111, network infrastructure devices 105B, 105C, and proxies 109A, 109B are also illustrated.

As illustrated, there are multiple user devices 101A, 101B, 101C in one cluster 103A. The user devices in the network cluster 103A are in geographic proximity, and packets from/to the user devices in the network cluster 103A utilize the same network access points, such as the illustrated network infrastructure devices 105A, 105B, due in large part to physical network structure and connections.

In accordance with the usual techniques, a call between two user devices can be divided into packets. A packet between a user device 101A in one network cluster 103A and a different user device 101D in a different cluster 103B follows a routing path 113. Other packets between the user devices 101A, 101D can follow the same or different routing paths, in accordance with the principles of packet networking. Routing paths followed by packets between two network clusters (even for different user devices) can be the same or similar, by being transferred between all or most of the same network infrastructure devices. The routing paths used for the call can affect the quality of the user experience. Also, time of day can affect the call experience.

Additionally, each of the user devices 101A-101I can be a different type of device, and/or can have different device configurations, and/or can have other different structural considerations such as a quality of a physical line to the device, noise at the building housing the user device, signal level, wiring in the building, and the like. Some devices also have an ability to perform diagnostics and send more detailed information about the device configuration and conditions to a network infrastructure device.

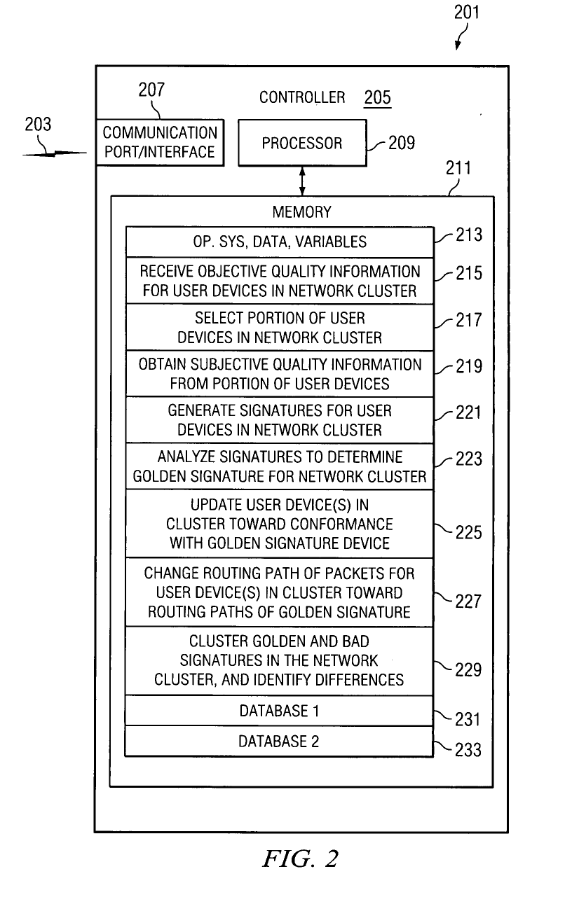

Referring now to FIG. 2, a block diagram illustrating portions of a system for managing user call experiences in a packet network will be discussed and described. The system 201 may include one or more controllers 205. The controller 205 can include one or more communication ports 207 for wired or wireless communication 203 with an external device, a processor 209, and a memory 211. Other devices can also be provided as desired, such as a speaker, a visual display, and/or a user input device such as a keypad (not illustrated).

The processor 209 may comprise one or more microprocessors and/or one or more digital signal processors. The memory 211 may be coupled to the processor 209 and may comprise a read-only memory (ROM), a random-access memory (RAM), a programmable ROM (PROM), and/or an electrically erasable read-only memory (EEPROM). The memory 211 may include multiple memory locations for storing, among other things, an operating system, data and variables 213 for programs executed by the processor 209; computer programs for causing the processor to operate in connection with various functions such as receiving 215 objective quality information for user devices in a network cluster, selecting 217 a portion of the user devices in the network cluster, obtaining 219 subjective quality information from the portion of user devices, generating 221 signatures for the user devices in the network cluster, analyzing 223 signatures to determine golden signature(s) for the network cluster, updating 225 user device(s) in the network cluster toward conformance with the device(s) having the golden signature, changing 227 a routing path of packets for user device(s) in the network cluster toward the routing paths of the golden signature(s), and clustering 229 golden and bad signatures in the network cluster and identifying the differences therebetween; a database 231 of information used for managing user call experiences such as signatures; and a database 233 for other information used by the processor 209. The computer programs may be stored, for example, in ROM or PROM and may direct the processor 209 in controlling the operation of the system 201.

The processor 209 may be programmed to receive 215 objective quality information for user devices in a network cluster. In accordance with known techniques, a service provider can collect objective quality information from the network infrastructure devices and proxies in the packet communication network. For example, a service provider can cause one of the network infrastructure devices to query user devices, for example those equipped with diagnostics such as PIQUA or others, and/or can receive information from the user devices. Such information can include information about a call quality, such as echo, packet errors, and diagnostic information and/or results; the information can also include the configuration of the user device; as well as the other objective quality information which can be used in the signature. RTCPXR (RTP Control Protocol extended report) is another example of a technique that can be used to collect objective quality information.

Objective quality information be collected immediately after a call and can thus be associated with a particular call. Also, objective quality information can be stored in association with a time, a particular call, a particular device, and/or a particular routing path, such as in accordance with known techniques.

Objective quality information can be collected from all of the user devices which are participating in a network cluster.

The processor 209 may be programmed to select 217 a portion of the user devices in the network cluster. Subjective quality information can be collected for a portion of the user devices in a network cluster. The appropriate number of user devices to be included in the portion from which subjective qualify information is collected, can be determined in accordance with statistical techniques, for example, but is likely to be just a few of the users. The particular devices which are selected to be in the portion can be determined for example, randomly, or in accordance with statistical techniques.

The processor 209 may be programmed to obtain 219 subjective quality information from the portion of user devices. Subjective quality information reflects the user's personal evaluation of the service. Subjective quality information can be collected from interactive with the user himself or herself. Thus, subjective quality information can be collected by polling users, letters to users, e-mail to users, and the like. Subjective quality information which is collected can be include a rating (for example, 1-10, or “unacceptable, fair, very good”), a comparison (for example, “better or worse than . . . ”), a descriptive text (for example, call quality is “fuzzy,” “quiet,” “long latency,” “clear”).

Subjective quality information can be collected immediately after a call and can thus be associated with a particular call. Alternatively, or in addition, subjective quality information can be generally associated with a particular user device.

The processor 209 may be programmed to generate 221 signatures for the user devices in the network cluster. The subjective quality information (if any) and the objective quality information can be combined to form a signature for each device. Furthermore, the signature can be associated with not only a particular user device, but also a particular call.

The processor 209 may be programmed to analyze 223 signatures to determine golden signature(s) for the network cluster, and to cluster 229 golden and bad signatures in the network cluster and identifying the differences therebetween. The signatures of those devices which are in the portion having subjective information, can be clustered, that is, examined to determine which signatures are “golden” (indicated as representing a call experience preferred by users, that is, having better ratings). Similarly, the signatures of those devices which are in the portion having subjective information can be clustered, that is, examined to determine which are bad (having poor ratings or not preferred by users).

The processor 209 may be programmed to update 225 user device(s) in the network cluster toward conformance with the device(s) having the golden signature, and/or to change 227 a routing path of packets for user device(s) in the network cluster toward the routing paths of the golden signature(s). It is expected that user devices in a network cluster which have objective quality information similar to the golden signature(s) should result in desirable user call experiences. Conversely, devices which have objective quality information similar to the bad signatures are not expected to result in desirable user call experiences. The differences between the golden signatures can be identified, in terms of user device configurations, network elements, and/or routing paths. The user devices that do not have golden signatures can be instructed to update their configurations and/or can have their routing paths changed toward the configurations and/or routing paths of the golden signatures, in accordance with known techniques. Hence, the golden signatures can be utilized by a service provider for subsequent comparisons to other signatures for devices within the network cluster, to improve the quality of the user call experience in a packet network, for trouble shooting, and/or for cluster analysis of the network cluster.

The database 1 can store the signatures. A signature can include the objective quality information and the subjective quality information for a particular device, optionally associated with a particular call. The objective quality information in the signature can identify the call, network elements specific to the call, routing path(s) specific to the call, a user device configuration during the call, and user device diagnostics. The signature can also indicate which network cluster it is associated with.

It should be understood that various logical groupings of functions are described herein. Different realizations may omit one or more of these logical groupings. Likewise, in various realizations, functions may be grouped differently, combined, augmented, and/or distributed among different processors or systems. Furthermore, variations can omit functions. For example, a variation of the system 201 can omit the function of changing the routing path 227 of packets for user devices, or the function of changing the routing path 227 can be distributed among several systems 201. Similarly, the function of generating 221 signatures can be implemented on a first variation system 201, and the function of updating 225 user devices toward conformance with the golden signature device can be implemented on a second variation of the system 201.

Likewise, although the illustrated embodiment indicates that the signatures are stored in database 1 231 of the memory of the system 201, all or a portion of the signatures can be stored separately from the system 201.

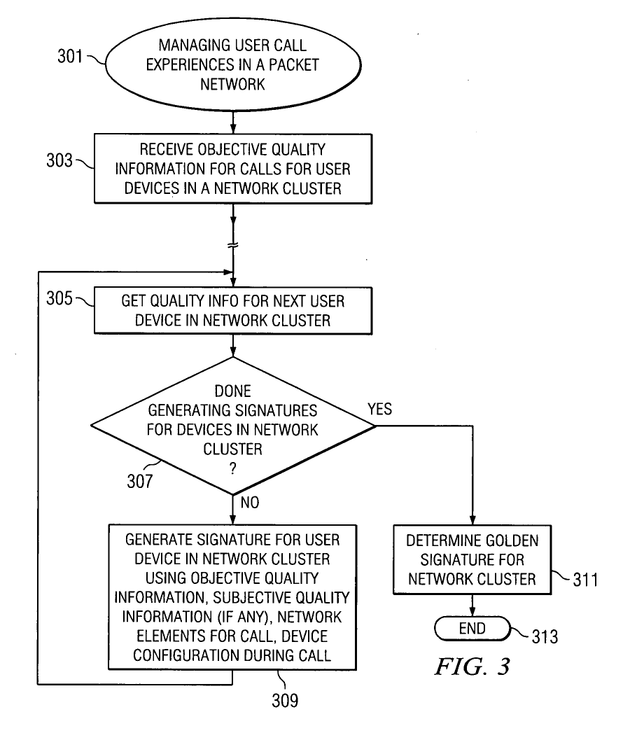

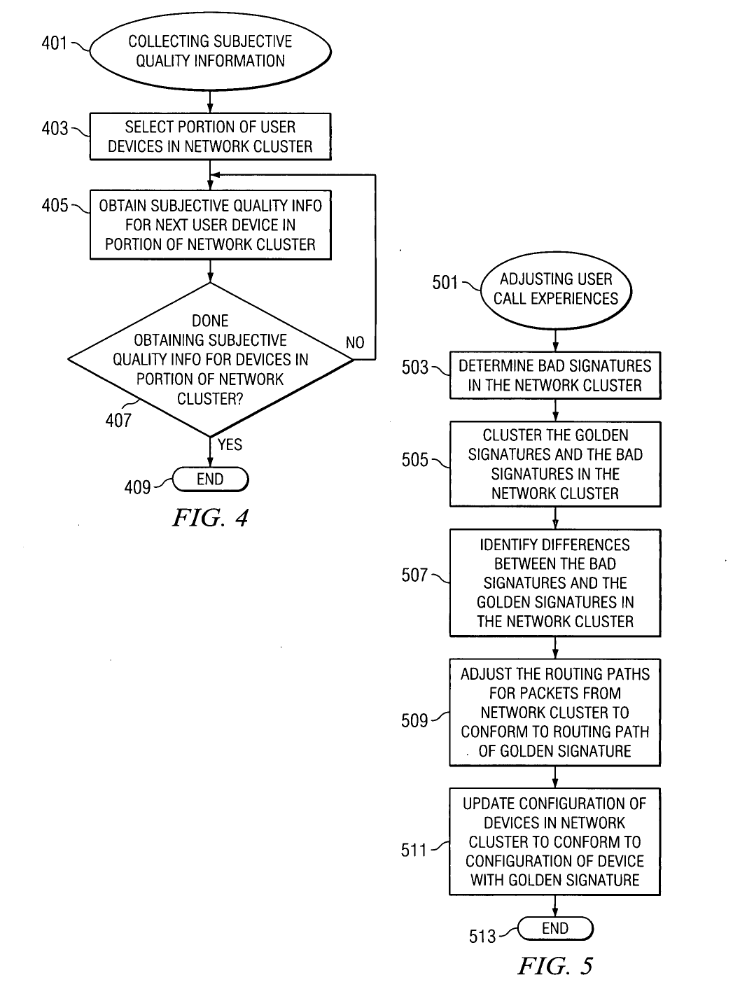

FIG. 3, FIG. 4, and FIG. 5 are flow charts which illustrate procedures utilized in managing user call experiences. FIG. 3 provides an illustrating of the general procedure, whereas FIG. 4 shows an example flow for collecting the subjective quality information, and FIG. 5 shows a flow for adjusting a user call experience. The procedures illustrated in these figures can be executed at substantially linearly, and/or at different, separate times, if preferred.

Referring now to FIG. 3, a flow chart illustrating a procedure for managing user call experiences in a packet network 301 will be discussed and described. The procedure can advantageously be implemented on, for example, a processor of a controller, described in connection with FIG. 2 or other apparatus appropriately arranged.

In overview, the procedure 301 includes receiving 303 objective quality information, getting 305 quality information for another device in the network cluster, and if 307 not done with the network cluster, generating 309 a signature for the user device, but if 307 done with the network cluster, determining 311 the golden signature(s) for the network cluster. These are described in more detail below, however, omitting details which have previously been discussed.

The procedure 301 can include receiving 303 objective quality information. The objective quality information for the calls of the user devices in a network cluster can be received in response to a request, and/or can be received asynchronously without being requested, and/or can be collected from network infrastructure devices which generally store such information. The objective quality information is associated with a particular user device and a particular network cluster, and optionally a particular call.

The procedure 301 can include getting 305 stored subjective quality information (if available) and objective quality information for each of the devices in the network cluster. The subjective quality information can be obtained previously via a process, such as that described in connection with FIG. 4, and stored. Using the stored subjective qualify information (if any) and objective quality information for the same device, and optionally for the same call, the procedure can generate 309 the signature, further incorporating other information such as network elements for the call, and the device configuration during the call.

If 307 not done with the network cluster, the procedure 301 can loop to continue generating 309 a signature for the remaining user devices in the network cluster. When done 307 processing the user devices in the network cluster, the procedure 301 can determine 311 the golden signature(s) for the network cluster.

The procedure 301 can end 313 when complete. It will be appreciated that the procedure 301 can be repeated for other network clusters in the packet network.

Referring now to FIG. 4, a flow chart illustrating a procedure for collecting subjective quality information 401 will be discussed and described. The procedure can advantageously be implemented on, for example, a processor of a controller, described in connection with FIG. 2 or other apparatus appropriately arranged.

The process 401 can include selecting 403 user devices in the network cluster, as described above. The process 401 also includes obtaining 405 subjective quality information for each of the user devices in that portion of the network cluster, also as described previously in greater detail.

The process 401 then checks 407 if it is done with obtaining subjective quality information for the devices in the portion of the network cluster. If not, the process 401 can loop to obtain 405 subjective quality information for the remaining selected user devices in the portion of the network cluster.

The process 401 can end 409 when complete. The procedure can be repeated for other network clusters in the packet network.

Referring now to FIG. 5, a flow chart illustrating a procedure for adjusting user call experiences in a packet network 501 will be discussed and described. The procedure can advantageously be implemented on, for example, a processor of a controller, described in connection with FIG. 2 or other apparatus appropriately arranged.

In overview, the procedure includes determining 503 bad signatures in the network cluster, clustering 505 the golden signatures and bad signatures I the network cluster, identifying 507 differences between the bad and golden signatures, adjusting 509 routing paths to conform with the golden signature routing path, and updating 511 device configurations to conform with the golden signatures. Each of these is described in more detail below, however, details which have been provided above will be omitted below.

The process 501 can include determining 503 bad signatures in the network cluster, based on the subjective quality information, for those signatures which include subjective quality information.

The process 501 can include clustering 505 the golden signatures and bad signatures in the network cluster. Clustering has been described in more detail above.

The process 501 can include identifying 507 differences between the bad and golden signatures. For example, the differences can include network topology, device configurations, routing paths, and the like.

The process 501 can include adjusting 509 routing paths to conform to the golden signature routing path. For example, the network infrastructure devices can be instructed as to which routing paths to use and which to avoid, in accordance with conventional techniques. Also, the user devices can be instructed to specify specific network topology to use, in accordance with conventional techniques.

The process 501 can include updating 511 device configurations to conform to the golden signatures. Updating device configurations has been described above in more detail.

The process 501 can end 513 when complete. The procedure 501 can be performed for other user devices in the network cluster, and for other network clusters.

Furthermore, the communication networks of interest include those that transmit information in packets, for example, those known as packet switching networks that transmit data in the form of packets, where messages can be divided into packets before transmission, the packets are transmitted, and the packets are routed over network infrastructure devices to a destination where the packets are recompiled into the message. Such networks include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, UDP/UP (Universal Datagram Protocol/Universal Protocol), IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

“User device” as used herein means equipment located at a customer location which provides quality voice and voice and/or data capability for the user, sometimes referred to as a customer premise/purchased equipment (CPE), a gateway, a subscriber unit, a wireless subscriber device or the like. Each of these terms denotes a device sometimes associated with a user or subscriber, including a wireless mobile device or wired device that may be used with a public network, for example in accordance with a service agreement, or within a private network such as an enterprise network. Examples of such units include devices variously referred to as personal digital assistants, personal assignment pads, personal computers, SIP phones with multi-media communication capabilities, VoIP phones, video phones, cellular handsets, cellular phones, IP Phones, processors with softphone software, SIP devices, hardware endpoints, or equivalents thereof provided such units are constructed to communicate over a packet network or more particularly a VOP network. The user device optionally can integrate one or more other functions such as WLAN (wireless local area network), LAN (local area network) switch, NAT/FW (network address translation/firewall); and optionally can interface to an ISP (Internet service provider) access technologies, QOS (quality of service), home wiring, and the like.

Some varieties of user devices can take advantage of diagnostics available in a device, for example, a PIQUA-enabled device available from Texas Instruments. Diagnostics can invoke diagnostic tools and collect measurements and statistics. Information gathered by the diagnostics can be communicated externally. Diagnostics can include, for example, packet traces, bit error rate calculations, diagnostic loop backs, call and error statistics, echo cancellation modes, time stamps, and/or action-oriented triggers, and the like.

The network infrastructure devices of particular interest are those providing or facilitating voice communications services networks, such as edge routers, media gateways, centralized media gateways, session border controllers, trunk gateways, media boxes, call servers, and the like, and variants or evolutions thereof. It should be noted that the term network infrastructure device denotes a device or software that receives packets from a communication network, determines a next network point to which the packets should be forwarded toward their destinations as designated in communication packets, and then forwards the packets on the communication network. Examples of network infrastructure devices include devices and/or software which are sometimes referred to as routers, edge routers, switches, bridges, brouters, gateways, media gateways, centralized media gateways, session border controllers, trunk gateways, call servers, and the like, and variants or evolutions thereof.

The designation “network elements” as used herein includes user devices and network infrastructure devices.

“Network cluster” is a term known in the art, and indicates a grouping of user devices based on network packet traffic and geographic node placement. The user devices in the cluster typically route packets through the same network infrastructure device, usually due to geographic proximity; that network infrastructure device is sometimes referred to as an access point to the packet network for the network cluster. Various existing technology, and modifications and improvements thereof, can be utilized to determine a network cluster.

“Golden signature” as used herein is a signature which indicates a call experience preferred by a user, against which other signatures can be compared.

The term “Portion” as used herein with respect to the user devices in the network cluster means (i) one or more, preferably two or more, even more preferably three or more; and also less than all, preferably less than half, even more preferably 10% or less. Moreover, a sampling size for the number of user devices to be included in the portion can be ascertained in accordance with statistical techniques, so that the portion can be relied upon as a representative indication of the user devices in the network cluster.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A computer-implemented method for managing user call experiences in a packet network, wherein user devices are grouped into network clusters, wherein network elements in the packet network can be different for different calls for the same user device, comprising:
at a network infrastructure device, receiving, from network elements, objective quality information for calls on a packet network for each user device of plural user devices in a network cluster in the packet network;
selecting a portion of the user devices in the network cluster, interacting with each user device of the portion to obtain subjective quality information for each user device of the portion, and receiving the subjective quality information, wherein the subjective quality information represents a call experience rating;
at the network infrastructure device, generating a signature for each of the plural user devices in the network cluster using the objective quality information for the each user device in the network cluster and any subjective quality information for the each user device, wherein the signature represents a user experience during a call, indicates network elements specific to the call, and indicates a user device configuration during the call; and
analyzing the signatures corresponding to the user devices of the portion to determine a golden signature for the network cluster, wherein the golden signature represents a preferred call experience.

2. The method of claim 1, wherein the signature further is specific to the call.

3. The method of claim 1, wherein the packet network is a voice over packet network.

4. The method of claim 1, further comprising obtaining a configuration of the user device associated with the golden signature, and updating at least one other user device in the network cluster towards conformance with the user device configuration associated with the golden signature.

5. The method of claim 1, further comprising
obtaining a routing path associated with the golden signature; and
changing the routing path of packets to be sent to or from other user devices in the network cluster to conform toward routing paths in the golden signature.

6. The method of claim 1, further comprising
analyzing the signatures in the network cluster to determine bad signatures;
clustering the golden signatures and the bad signatures; and
identifying the differences of the network elements, the user device configurations, and the routing paths between the golden signatures and the bad signatures.

7. The method of claim 1, wherein the signature further includes a network topology for the user device, and a routing path for the call.

8. The method of claim 1, wherein the objective quality information includes diagnostics information received over the packet network from the user device.

9. A system for managing user call experiences in a packet network, wherein user devices are grouped into network clusters, wherein network elements in the packet network can be different for different calls for the same user device, comprising:
a memory configured to store signatures for a plurality of users; and
a processor, the processor being configured to facilitate
receiving, from network elements, objective quality information for calls on a packet network from each user device of plural user devices in a network cluster in the packet network,
selecting a portion of the user devices within the network cluster, and gathering subjective quality information from each user device of the portion, wherein the subjective quality information represents a call experience rating,
and generating a signature for each of the plural user devices in the network cluster using the objective quality information for the each user device in the network cluster,
wherein the signature represents a user experience during a call, indicates network elements specific to the call, and indicates a user device configuration during the call,
wherein the processor is further capable of using the signatures stored in the memory for subsequent comparisons within the network cluster, for troubleshooting, and for cluster analysis.

10. The system of claim 9, wherein the processor is further configured for analyzing the signatures for the user devices of the portion to determine a golden signature for the network cluster, wherein the golden signature represents a preferred call experience.

11. The system of claim 10, wherein the processor is further configured for obtaining a configuration of the user device associated with the golden signature, and updating at least one other user device in the network cluster towards conformance with the user device configuration associated with the golden signature.

12. The system of claim 10, further comprising
obtaining a routing path associated with the golden signature; and
changing the routing path of packets to be sent to or from other user devices in the network cluster to conform toward routing paths in the golden signature.

13. The system of claim 10, wherein the processor is further configured for
analyzing the signatures in the network cluster to determine bad signatures;
clustering the golden signatures and the bad signatures; and
identifying the differences of the network elements, the user device configurations, and the routing paths between the golden signatures and the bad signatures.

14. The system of claim 9, wherein the signature further is specific to the call, and includes a network topology for the user device and a routing path for the call.

15. The system of claim 9, wherein the packet network is a voice over packet network.

16. The system of claim 9, wherein the objective quality information includes diagnostics information received over the packet network from the user device.

17. A computer-readable medium comprising instructions for execution by a computer, the instructions including a computer-implemented method for managing user call experiences on a voice over packet (VOP) network, where user devices can be grouped into network clusters, where network elements in the VOP network can be different for different calls for the same user device, the instructions for implementing:
receiving, from network elements, objective quality information for calls on a packet network for each user device of plural user devices in a network cluster in the packet network;
selecting a portion of the user devices in the network cluster, interacting with each user device of the portion to obtain subjective quality information for each user device of the portion, and receiving the subjective quality information, wherein the subjective quality information represents a call experience rating;
at the network infrastructure device, generating a signature for each of the plural user devices in the network cluster using the objective quality information for the each user device in the network cluster and any subjective quality information for the each user device, wherein the signature represents a user experience during a call, indicates network elements specific to the call, and indicates user a device configuration during the call; and
analyzing the signatures for the user devices of the portion to determine a golden signature for the network cluster, wherein the golden signature represents a preferred call experience, wherein the signature further includes a network topology for the user device, and routing path for the call,
wherein the objective quality information includes diagnostics information received over the packet network from the user device.

18. The computer-readable medium of claim 17, further comprising instructions for implementing:
obtaining a configuration of the user device associated with the golden signature, and updating at least one other user device in the network cluster towards conformance with the user device configuration associated with the golden signature.

19. The computer-readable medium of claim 17, further comprising instructions for implementing:
obtaining a routing path associated with the golden signature; and
changing the routing path of packets to be sent to or from other user devices in the network cluster to conform toward routing paths in the golden signature.

20. The computer-readable medium of claim 17, further comprising instructions for implementing:
analyzing the signatures in the network cluster to determine bad signatures;
clustering the golden signatures and the bad signatures; and
identifying the differences of the network elements, the user device configurations, and the routing paths between the golden signatures and the bad signatures.
